(19) United States
(12) Patent Application Publication
(10) Pub. No.: US 2026/0079800 A1
(43) Pub. Date: Mar. 19, 2026

(54) VIRTUALIZED FILE SERVER AND WITNESS-BASED HIGH AVAILABILITY

(71) Applicant: Nutanix, Inc., San Jose, CA (US)

(72) Inventors: Eric Wang, San Jose, CA (US); Kalpesh Ashok Bafna, Milpitas, CA (US); Manoj Naik, San Jose, CA (US); Ashwini Talele, San Jose, CA (US); Suresh Sivaprakasam, Saratoga, CA (US); Anish Jain, Bangalore (IN); Tao Guan, Aptos, CA (US)

(73) Assignee: Nutanix, Inc., San Jose, CA (US)

(21) Appl. No.: 19/327,898

(22) Filed: Sep. 12, 2025

Related U.S. Application Data
(60) Provisional application No. 63/694,751, filed on Sep. 13, 2024.
(60) Provisional application No. 63/855,280, filed on Jul. 31, 2025.

(51) Int. Cl. G06F 11/20; G06F 11/16

(52) U.S. Cl. CPC G06F 11/2069; G06F 11/1612; G06F 11/2076

(57) ABSTRACT

Disclosed is an improved approach to implement high availability for file servers in a virtualized computing environment. A high availability solution is provided that creates a global file system namespace across two clusters located at separate sites, where a synchronous storage replication is used to support the stretched container, allowing VMs and files stored in the container to be replicated in real-time between the two clusters.

### RELATED APPLICATIONS

This present application claims the benefit of priority to U.S. Provisional Application No. 63/694,751 titled “VIRTUALIZED FILE SERVER AND WITNESS-BASED HIGH AVAILABILITY,” filed on Sep. 13, 2024, and also claims the benefit of priority to U.S. Provisional Application No. 63/855,280 titled “VIRTUALIZED FILE SERVER AND WITNESS-BASED HIGH AVAILABILITY,” filed on Jul. 31, 2025, which are hereby incorporated by reference in their entirety.

### FIELD

This disclosure relates to distributed computing systems, and more particularly to techniques for managing high-availability file servers.

### BACKGROUND

As computing technologies have evolved, data has become more and more valuable. Accordingly, computer technologies have been developed that identify certain data to be “protected” so that it is accessible or available even in the presence of some disastrous event. For example, a backup system might be implemented to hold a copy of the data so that the copy can be accessed if the original data is damaged or destroyed (e.g., in a fire or computing system crash) or otherwise lost. Many variations of backup systems have been deployed. As an example, data comprising a hierarchy of files in a file system might be periodically written to some non-volatile storage (e.g., magnetic tape or other media) and stored at a second location so that the data can be restored if a disaster were to occur. This technique has the characteristic of requiring administrative intervention that incurs a relatively long “downtime” to restore the file system content from the backup media.

To address the long restore downtimes associated with such file system content, file systems are sometimes stored and managed in pairs of redundant file servers. Each of the file servers is often a dedicated computing entity (e.g., one or more workstations, one or more virtualized entities, etc.) that is configured to respond to requests for file access from various hosts, which hosts can be any computing entity in any location that is authorized to send and receive data to and from the file servers. By maintaining a redundancy between the pair of file servers, if one file server fails, then a second one of the redundant file servers can be consulted to access the file system content. The file server that failed can be brought back to an operational state (e.g., after remediation or replacement) and can then be synchronized with the second file server.

Unfortunately, procedures for performing failovers from one file server to another redundant file server are deficient, at least with respect to providing uninterrupted availability of file system content.

### SUMMARY

This summary is provided to introduce a selection of concepts that are further described below. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particularly desirable attribute or end result.

The present disclosure describes techniques used in systems, methods, and in computer program products for an improved approach to implement high availability for file servers in a virtualized computing environment. In particular, for a “metro availability” environment, embodiments of the invention provide a high availability solution that creates a global file system namespace across two clusters located at separate sites, where a synchronous storage replication is used to support the stretched container, allowing VMs and files stored in the container to be replicated in real-time between the two clusters.

The disclosed embodiments modify and improve over legacy approaches. In particular, the herein-disclosed techniques provide technical solutions that address the technical problems attendant to high availability for file servers in a stretch cluster. Such technical solutions involve specific implementations (i.e., data organization, data communications paths, module-to-module interrelationships, etc.) that relate to the software arts for improving computer functionality. Various applications of the herein-disclosed improvements in computer functionality serve to reduce demands for computer memory, reduce demands for computer processing power, reduce network bandwidth usage, and reduce demands for intercomponent communication. For example, when performing computer operations for high availability for file servers in a stretch cluster, both memory usage and CPU cycles demanded are significantly reduced as compared to the memory usage and CPU cycles that would be needed but for practice of the herein-disclosed techniques for deploying high availability solutions for file servers in a stretch cluster

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1A illustrates a clustered virtualization environment according to some particular embodiments.

FIG. 1B illustrates data flow within an example clustered virtualization environment according to particular embodiments.

FIG. 2A illustrates a clustered virtualization environment implementing a virtualized file server (VFS) according to particular embodiments.

FIG. 2B illustrates data flow within a clustered virtualization environment implementing a VFS instance.

FIG. 3A show a virtualization system HA (high availability) cluster.

FIG. 3B shows datastore that may be implemented where containers are created on both clusters.

FIG. 3C shows an alternate embodiment of an HA cluster.

FIG. 4A shows an approach to implement some embodiments of the invention.

FIG. 4B shows a flowchart according to some embodiments of the invention.

FIG. 5 shows an active protection domain flowchart for the primary site.

FIG. 6 shows a standby flowchart.

FIG. 7 shows how to create a stretch protection domain workflow.

FIG. 8 shows an example deployment scenario.

FIG. 9 shows a flowchart according to some embodiments of the invention for performing entity-based replication.

FIG. 10A, FIG. 10B, and FIG. 10C depict virtualized controller architectures comprising collections of interconnected components suitable for implementing embodiments of the present disclosure and/or for use in the herein-described environments.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the invention provide an improved approach to implement high availability for file servers in a virtualized computing environment. In particular, for a metro availability environment, embodiments of the invention provide a high availability solution that creates a global file system namespace across two clusters located at separate sites, where a synchronous storage replication is used to support the stretched container, allowing VMs and files stored in the container to be replicated in real-time between the two clusters.

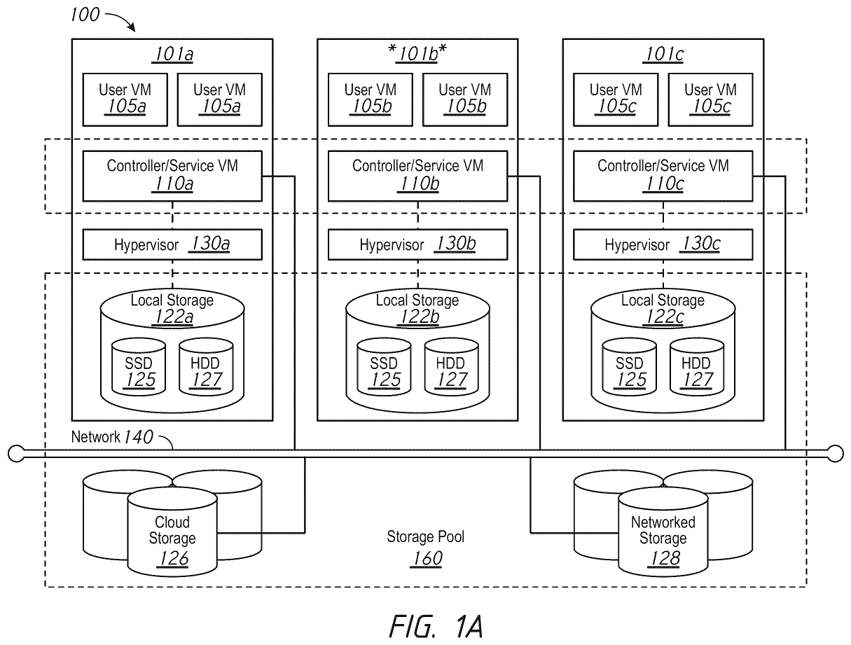

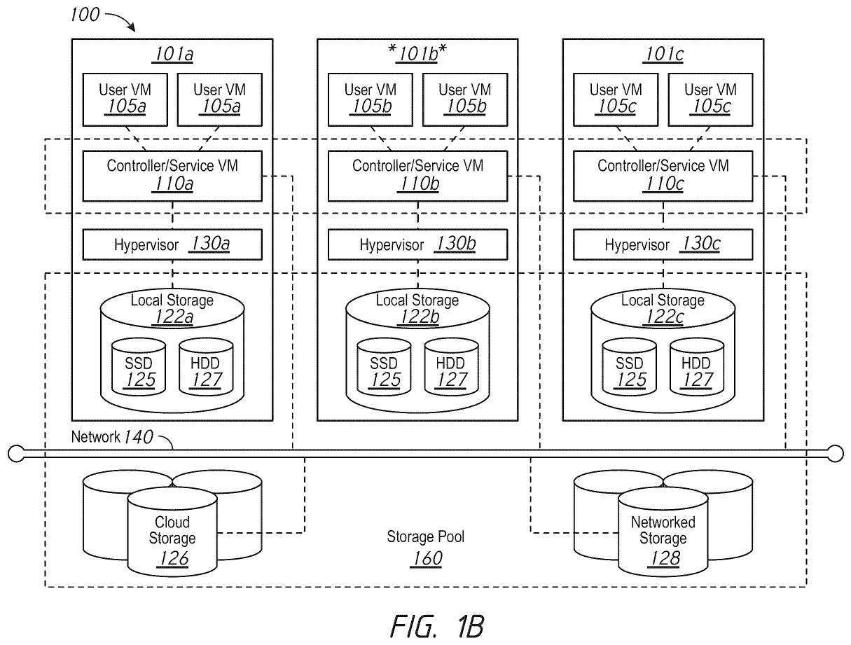

By way of background, FIG. 1A illustrates a clustered virtualization environment according to some particular embodiments. The architecture of FIG. 1A can be implemented for a distributed platform that contains multiple host machines 100 a-c that manage multiple tiers of storage. The multiple tiers of storage may include network-attached storage (NAS) that is accessible through network 140, such as, by way of example and not limitation, cloud storage 126, which may be accessible through the Internet, or local network-accessible storage 128 (e.g., a storage area network (SAN)). Unlike the prior art, the present embodiment also permits local storage 122 that is within or directly attached to the server and/or appliance to be managed as part of storage pool 160. Examples of such storage include Solid State Drives 125 (henceforth “SSDs”), Hard Disk Drives 127 (henceforth “HDDs” or “spindle drives”), optical disk drives, external drives (e.g., a storage device connected to a host machine via a native drive interface or a direct attach serial interface), or any other directly attached storage. These collected storage devices, both local and networked, form storage pool 160. Virtual disks (or “vDisks”) can be structured from the storage devices in storage pool 160, as described in more detail below. As used herein, the term vDisk refers to the storage abstraction that is exposed by a Controller/Service VM (CVM) to be used by a user VM. In some embodiments, the vDisk is exposed via iSCSI (“internet small computer system interface”) or NFS (“network file system”) and is mounted as a virtual disk on the user VM.

Each host machine 100 a-c runs virtualization software, such as VMWARE ESX(I), MICROSOFT HYPER-V, or REDHAT KVM. The virtualization software includes hypervisor 130 a-c to manage the interactions between the underlying hardware and the one or more user VMs 105 a, 105 b, 105 c that run client software. Though not depicted in FIG. 1A, a hypervisor may connect to network 140. In particular embodiments, a host machine 100 may be a physical hardware computing device; in particular embodiments, a host machine 100 may be a virtual machine.

CVMs 110 a-c are used to manage storage and input/output (“I/O”) activities according to particular embodiments. These special VMs act as the storage controller in the currently described architecture. Multiple such storage controllers may coordinate within a cluster to form a unified storage controller system. CVMs 110 may run as virtual machines on the various host machines 100, and work together to form a distributed system 110 that manages all the storage resources, including local storage 122, networked storage 128, and cloud storage 126. The CVMs may connect to network 140 directly, or via a hypervisor. Since the CVMs run independent of hypervisors 130 a-c, this means that the current approach can be used and implemented within any virtual machine architecture, since the CVMs can be used in conjunction with any hypervisor from any virtualization vendor.

A host machine may be designated as a leader node within a cluster of host machines. For example, host machine 100 b, as indicated by the asterisks, may be a leader node. A leader node may have a software component designated to perform operations of the leader. For example, CVM 110 b on host machine 100 b may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node.

Each CVM 110 a-c exports one or more block devices or NFS server targets that appear as disks to user VMs 105a and 105b. These disks are virtual, since they are implemented by the software running inside CVMs 110 a-c. Thus, to user VMs 105a and 105b, CVMs 110 a-c appear to be exporting a clustered storage appliance that contains some disks. All user data (including the operating system) in the user VMs 105a and 105b reside on these virtual disks.

Significant performance advantages can be gained by allowing the virtualization system to access and utilize local storage 122 as disclosed herein. This is because I/O performance is typically much faster when performing access to local storage 122 as compared to performing access to networked storage 128 across a network 140. This faster performance for locally attached storage 122 can be increased even further by using certain types of optimized local storage devices, such as SSDs. Further details regarding methods and mechanisms for implementing the virtualization environment illustrated in FIG. 1A are described in U.S. Pat. No. 8,601,473, which is hereby incorporated by reference in its entirety.

FIG. 1B illustrates data flow within an example clustered virtualization environment according to particular embodiments. As described above, one or more user VMs and a CVM may run on each host machine 100 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 160. Additionally or alternatively, Controller/Service VM 110 a-c may present an emulated storage controller either to the hypervisor or to user VMs to facilitate I/O operations. CVMs 110 a-c may be connected to storage within storage pool 160. CVM 110 a may have the ability to perform I/O operations using local storage 122 a within the same host machine 100 a, by connecting via network 140 to cloud storage 126 or networked storage 128, or by connecting via network 140 to local storage 122 b-c within another host machine 100 b-c (e.g., via connecting to another CVM 110 b or 110 c). In particular embodiments, any suitable computing system 700 may be used to implement a host machine 100.

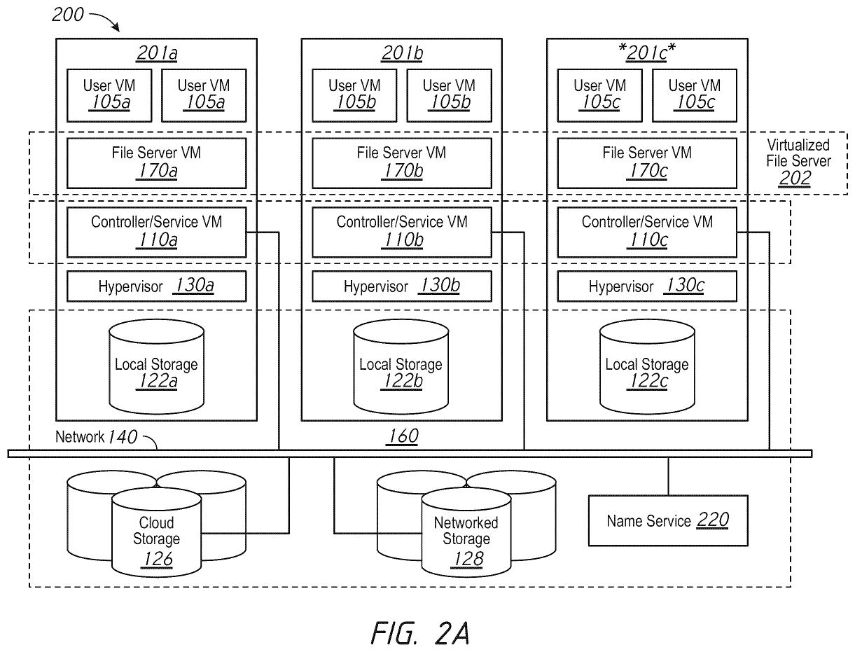

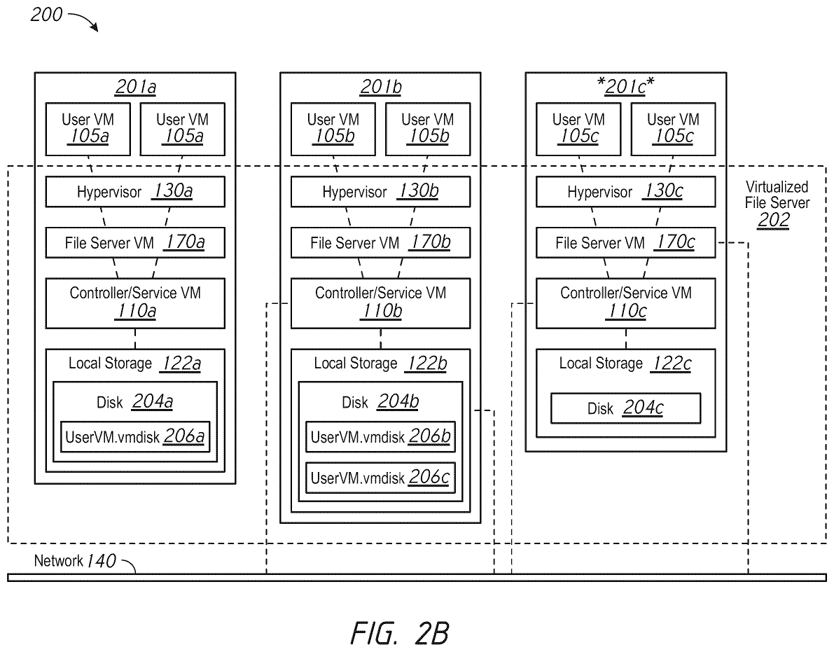

FIG. 2A illustrates a clustered virtualization environment implementing a virtualized file server (VFS) 202 according to particular embodiments. In particular embodiments, the VFS 202 provides file services to user virtual machines (user VMs). The file services may include storing and retrieving data persistently, reliably, and efficiently. The user virtual machines may execute user processes, such as office applications or the like, on host machines 201 a-c. The stored data may be represented as a set of storage items, such as files organized in a hierarchical structure of folders (also known as directories), which can contain files and other folders.

In particular embodiments, the VFS 202 may include a set of File Server Virtual Machines (FSVMs) 170 a-c that execute on host machines 201 a-c and process storage item access operations requested by user VMs executing on the host machines.

The FSVMs 170 a-c may communicate with storage controllers provided by CVMs 110 a-c executing on the host machines 201 a-c to store and retrieve files, folders, or other storage items on local storage 122 a-c associated with, e.g., local to, the host machines 201 a-c. The network protocol used for communication between user VMs 105a and 105b, FSVMs 170 a-c, and CVMs 110 a-c via the network 140 may be Internet Small Computer Systems Interface (iSCSI), Server Message Block (SMB), Network File System (NFS), pNFS (Parallel NFS), or another appropriate protocol.

For the purposes of VFS 202, host machine 201c may be designated as a leader node within a cluster of host machines. In this case, FSVM 170c on host machine 201c may be designated to perform such operations. A leader may be responsible for monitoring or handling requests from FSVMs on other host machines throughout the virtualized environment. If FSVM 170c fails, a new leader may be designated for VFS 202.

In particular embodiments, the user VMs may send data to the VFS 202 using write requests, and may receive data from it using read requests. The read and write requests, and their associated parameters, data, and results, may be sent between a user VM and one or more file server VMs (FSVMs) 170 a-c located on the same host machine as the user VM or on different host machines from the user VM. The read and write requests may be sent between host machines 201 a-c via network 140, e.g., using a network communication protocol such as iSCSI, CIFS, SMB, TCP, IP, or the like. When a read or write request is sent between two VMs located on the same one of the host machines 201 a-c (e.g., between the user VM and the FSVM 170 a located on the host machine 201 a), the request may be sent using local communication within the host machine 201 a instead of via the network 140. As described above, such local communication may be substantially faster than communication via the network 140. The local communication may be performed by, e.g., writing to and reading from shared memory accessible by the user VM and the FSVM 170 a, sending and receiving data via a local “loopback” network interface, local stream communication, or the like.

In particular embodiments, the storage items stored by the VFS 202, such as files and folders, may be distributed amongst multiple host machines 201 a-c. In particular embodiments, when storage access requests are received from the user VMs, the VFS 202 identifies host machines 201 a-c at which requested storage items, e.g., folders, files, or portions thereof, are stored, and directs the user VMs to the locations of the storage items.

When a user application executing in a user VM on one of the host machines 201 a initiates a storage access operation, such as reading or writing data, the user VM may send the storage access operation in a request to one of the FSVMs 170 a-c on one of the host machines 201 a-c.

As an example and not by way of limitation, the location of a file or a folder may be pinned to a particular host machine 201 a by sending a file service operation that creates the file or folder to a CVM 110 a located on the particular host machine 201 a. The CVM 110 a subsequently processes file service commands for that file and sends corresponding storage access operations to storage devices associated with the file. The CVM 110 a may associate local storage 122 a with the file if there is sufficient free space on local storage 122 a. Alternatively, the CVM 110 a may associate a storage device located on another host machine 201 b, e.g., in local storage 122 b, with the file under certain conditions, e.g., if there is insufficient free space on the local storage 122 a, or if storage access operations between the CVM 110 a and the file are expected to be infrequent. Files and folders, or portions thereof, may also be stored on other storage devices, such as the network-attached storage (NAS) or the cloud storage 126 of the storage pool 160.

In particular embodiments, a name service, such as that specified by the Domain Name System (DNS) Internet protocol, may communicate with the host machines 201 a-c via the network 140 and may store a database of domain name (e.g., host name) to IP address mappings. The name service may be queried by the User VMs to determine the IP address of a particular host machine 201 a-c given a name of the host machine, e.g., to determine the IP address of the host name ip-addr1 for the host machine 201 a. The name service may be located on a separate server computer system or on one or more of the host machines 201. The names and IP addresses of the host machines of the VFS instance 202, e.g., the host machines 201, may be stored in the name service so that the user VMs may determine the IP address of each of the host machines 201. The name of each VFS instance 202, e.g., FS1, FS2, or the like, may be stored in the name service in association with a set of one or more names that contains the name(s) of the host machines 201 of the VFS instance 202. For example, the file server instance name FS1.domain.com may be associated with the host names ip-addr1, ip-addr2, and ip-addr3 in the name service 220, so that a query of the name service for the server instance name “FS1” or “FS1.domain.com” returns the names ip-addr1, ip-addr2, and ip-addr3. Further, the name service may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines 201, since the user VMs submit requests to the name service for the address of the VFS instance 202 for storage items for which the user VMs 105 do not have a record or cache entry, as described below.

In particular embodiments, each FSVM 170 may have two IP addresses: an external IP address and an internal IP address. The external IP addresses may be used by SMB/CIFS clients, such as user VMs, to connect to the FSVMs 170. The external IP addresses may be stored in the name service 220. The IP addresses ip-addr1, ip-addr2, and ip-addr3 described above are examples of external IP addresses. The internal IP addresses may be used for iSCSI communication to CVMs 110, e.g., between the FSVMs 170 and the CVMs 110, and for communication between the CVMs 110 and storage devices in the storage pool 160. Other internal communications may be sent via the internal IP addresses as well, e.g., file server configuration information may be sent from the CVMs 110 to the FSVMs 170 using the internal IP addresses, and the CVMs 110 may get file server statistics from the FSVMs 170 via internal communication as needed.

Since the VFS 202 is provided by a distributed set of FSVMs 170 a-c, the user VMs that access particular requested storage items, such as files or folders, do not necessarily know the locations of the requested storage items when the request is received. A distributed file system protocol, e.g., MICROSOFT DFS or the like, is therefore used, in which a user VM may request the addresses of FSVMs 170 a-c from a name service (e.g., DNS). The name service may send one or more network addresses of FSVMs 170 a-c to the user VM, in an order that changes for each subsequent request. These network addresses are not necessarily the addresses of the FSVM 170 b on which the storage item requested by the user VM is located, since the name service does not necessarily have information about the mapping between storage items and FSVMs 170 a-c. Next, the user VM 170 a may send an access request to one of the network addresses provided by the name service, e.g., the address of FSVM 170 b. The FSVM 170 b may receive the access request and determine whether the storage item identified by the request is located on the FSVM 170 b. If so, the FSVM 170 b may process the request and send the results to the requesting user VM 105 a. However, if the identified storage item is located on a different FSVM 170 c, then the FSVM 170 b may redirect the user VM to the FSVM 170c on which the requested storage item is located by sending a “redirect” response referencing FSVM 170c to the user VM. The user VM may then send the access request to FSVM 170 c, which may perform the requested operation for the identified storage item.

A particular VFS 202, including the items it stores, e.g., files and folders, may be referred to herein as a VFS “instance” 202 and may have an associated name, e.g., FS1, as described above. Although a VFS instance 202 may have multiple FSVMs distributed across different host machines 201, with different files being stored on different host machines 201, the VFS instance 202 may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance 202 via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients such as user VMs by name, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance 202 by specifying the file names or path names, e.g., the path name “\Folder-1\File-1”, in storage access operations. If the storage items are stored on a share (e.g., a shared drive), then the share name may be used to access the storage items, e.g., via the path name “\\Share-1\Folder-1\File-1” to access File-1 in folder Folder-1 on a share named Share-1.

In particular embodiments, although the VFS instance 202 may store different folders, files, or portions thereof at different locations, e.g., on different host machines 201, the use of different host machines or other elements of storage pool 160 to store the folders and files may be hidden from the accessing clients. The share name is not necessarily a name of a location such as a host machine 201. For example, the name Share-1 does not identify a particular host machine 201 on which storage items of the share are located. The share Share-1 may have portions of storage items stored on three host machines 201 a-c, but a user may simply access Share-1, e.g., by mapping Share-1 to a client computer, to gain access to the storage items on Share-1 as if they were located on the client computer. Names of storage items, such as file names and folder names, are similarly location-independent. Thus, although storage items, such as files and their containing folders and shares, may be stored at different locations, such as different host machines 201 a-c, the files may be accessed in a location-transparent manner by clients (such as the user VMs). Thus, users at client systems need not specify or know the locations of each storage item being accessed. The VFS 202 may automatically map the file names, folder names, or full path names to the locations at which the storage items are stored. As an example and not by way of limitation, a storage item's physical location may be specified by the name or address of the host machine 201 a-c on which the storage item is located, the name, address, or identity of the FSVM 170 a-c that provides access to the storage item on the host machine 201 a-c on which the storage item is located, the particular device (e.g., SSD or HDD) of the local storage 122 a (or other type of storage in storage pool 160) on which the storage item is located, and the address on the device, e.g., disk block numbers. A storage item such as a file may be divided into multiple parts that may be located on different host machines 201 a-c, in which case access requests for a particular portion of the file may be automatically mapped to the location of the portion of the file based on the portion of the file being accessed (e.g., the offset from the beginning of the file and the number of bytes being accessed).

In particular embodiments, VFS 202 determines the location, e.g., particular host machine 201 a-c, at which to store a storage item when the storage item is created. For example, a FSVM 170 a may attempt to create a file or folder using a Controller/Service VM 110 a on the same host machine 201 a as the user VM that requested creation of the file, so that the Controller/Service VM 110 a that controls access operations to the file folder is co-located with the user VM. In this way, since the user VM is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM 110 a on the same host machine as the FSVM 170 a, the FSVM 170 a may identify it and use it by default. If there is no local CVM 110 a on the same host machine as the FSVM 170 a, a delay may be incurred for communication between the FSVM 170 a and a CVM 110 b on a different host machine 201 b. Further, the VFS 202 may also attempt to store the file on a storage device that is local to the CVM 110 a being used to create the file, such as local storage 122 a, so that storage access operations between the CVM 110 a and local storage 122 a may use local or short-distance communication.

In particular embodiments, if a CVM 110 a is unable to store the storage item in local storage 122 a, e.g., because local storage 122 a does not have sufficient available free space, then the file may be stored in local storage 122 b of a different host machine 201 b. In this case, the stored file is not physically local to the host machine 201 a, but storage access operations for the file are performed by the locally-associated CVM 110 a and FSVM 170 a, and the CVM 110 a may communicate with local storage 122 b on the remote host machine 201 b using a network file sharing protocol, e.g., iSCSI, SAMBA or the like.

In particular embodiments, if a virtual machine, such as a user VM 105 a, CVM 110 a, or FSVM 170 a, moves from a host machine 201 a to a destination host machine 201 b, e.g., because of resource availability changes, and data items such as files or folders associated with the VM are not locally accessible on the destination host machine 201 b, then data migration may be performed for the data items associated with the moved VM to migrate them to the new host machine 201 b, so that they are local to the moved VM on the new host machine 201 b. FSVMs 170 may detect removal and addition of CVMs 110 (as may occur, for example, when a CVM 110 fails or is shut down) via the iSCSI protocol or other technique, such as heartbeat messages. As another example, a FSVM 170 may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 202 may change the location of the file by, for example, copying the file from its existing location(s), such as local storage 122 a of a host machine 201 a, to its new location(s), such as local storage 122 b of host machine 201 b (and to or from other host machines, such as local storage 122 c of host machine 201c if appropriate), and deleting the file from its existing location(s). Write operations on the file may be blocked or queued while the file is being copied, so that the copy is consistent. The VFS 202 may also redirect storage access requests for the file from an FSVM 170 a at the file's existing location to a FSVM 170 b at the file's new location.

In particular embodiments, VFS 202 includes at least three File Server Virtual Machines (FSVMs) 170 a-c located on three respective host machines 201 a-c. To provide high-availability, there may be a maximum of one FSVM 170 a for a particular VFS instance 202 per host machine 201 in a cluster. If two FSVMs 170 are detected on a single host machine 201, then one of the FSVMs 170 may be moved to another host machine automatically, or the user (e.g., system administrator) may be notified to move the FSVM 170 to another host machine. The user may move a FSVM 170 to another host machine using an administrative interface that provides commands for starting, stopping, and moving FSVMs 170 between host machines 201.

In particular embodiments, two FSVMs 170 of different VFS instances 202 may reside on the same host machine 201 a. If the host machine 201 a fails, the FSVMs 170 on the host machine 201 a become unavailable, at least until the host machine 201 a recovers. Thus, if there is at most one FSVM 170 for each VFS instance 202 on each host machine 201 a, then at most one of the FSVMs 170 may be lost per VFS 202 per failed host machine 201. As an example, if more than one FSVM 170 for a particular VFS instance 202 were to reside on a host machine 201 a, and the VFS instance 202 includes three host machines 201 a-c and three FSVMs 170, then loss of one host machine would result in loss of two-thirds of the FSVMs 170 for the VFS instance 202, which would be more disruptive and more difficult to recover from than loss of one-third of the FSVMs 170 for the VFS instance 202.

In particular embodiments, users, such as system administrators or other users of the user VMs 105a, 105b, may expand the cluster of FSVMs 170 by adding additional FSVMs 170. Each FSVM 170 a may be associated with at least one network address, such as an IP (Internet Protocol) address of the host machine 201 a on which the FSVM 170 a resides. There may be multiple clusters, and all FSVMs of a particular VFS instance are ordinarily in the same cluster. The VFS instance 202 may be a member of a MICROSOFT ACTIVE DIRECTORY domain, which may provide authentication and other services such as name service 220.

FIG. 2B illustrates data flow within a clustered virtualization environment implementing a VFS instance 202 in which stored items such as files and folders used by user VMs 105 are stored locally on the same host machines 201 as the user VMs 105 according to particular embodiments. As described above, one or more user VMs 105 and a Controller/Service VM 110 may run on each host machine 201 along with a hypervisor 130. As a user VM 105 processes I/O commands (e.g., a read or write operation), the I/O commands may be sent to the hypervisor 130 on the same server or host machine 201 as the user VM 105. For example, the hypervisor 130 may present to the user VMs 105 a VFS instance 202, receive an I/O command, and facilitate the performance of the I/O command by passing the command to a FSVM 170 that performs the operation specified by the command. The VFS 202 may facilitate I/O operations between a user VM 105 and a virtualized file system. The virtualized file system may appear to the user VM 105 as a namespace of mappable shared drives or mountable network file systems of files and directories. The namespace of the virtualized file system may be implemented using storage devices in the local storage 122, such as disks 204, onto which the shared drives or network file systems, files, and folders, or portions thereof, may be distributed as determined by the FSVMs 170. The VFS 202 may thus provide features disclosed herein, such as efficient use of the disks 204, high availability, scalability, and others. The implementation of these features may be transparent to the user VMs 105a, 105b. The FSVMs 170 may present the storage capacity of the disks 204 of the host machines 201 as an efficient, highly-available, and scalable namespace in which the user VMs 105a, 105b may create and access shares, files, folders, and the like.

As an example, a network share may be presented to a user VM 105 as one or more discrete virtual disks, but each virtual disk may correspond to any part of one or more virtual or physical disks 204 within storage pool 160. Additionally or alternatively, the FSVMs 170 may present a VFS 202 either to the hypervisor 130 or to user VMs 105 of a host machine 201 to facilitate I/O operations. The FSVMs 170 may access the local storage 122 via Controller/Service VMs 110. As described with reference to FIG. 1B, a Controller/Service VM 110 a may have the ability to perform I/O operations using local storage 122 a within the same host machine 201 a by connecting via the network 140 to cloud storage 126 or networked storage 128, or by connecting via the network 140 to local storage 122 b-c within another host machine 201 b-c (e.g., by connecting to another Controller/Service VM 110 b-c).

In particular embodiments, each user VM 105 may access one or more virtual disk images stored on one or more disks of the local storage, the cloud storage, and/or the networked storage. The virtual disk images may contain data used by the user VMs, such as operating system images, application software, and user data, e.g., user home folders and user profile folders. For example, consider a virtual machine image. The virtual machine image may be a file named UserVM105a.vmdisk (or the like) stored on a disk of local storage of a host machine. The virtual machine image may store the contents of the user VM's hard drive. The disk on which the virtual machine image is “local to” the user VM on the host machine because the disk is in local storage of the host machine on which the user VM is located. Thus, the user VM may use local (intra-host machine) communication to access the virtual machine image more efficiently, e.g., with less latency and higher throughput, than would be the case if the virtual machine image were stored on another disk of local storage of a different host machine, because inter-host machine communication across the network would be used in the latter case.

In particular embodiments, since local communication is expected to be more efficient than remote communication, the FSVMs 170 may store storage items, such as files or folders, e.g., the virtual disk images 206, on local storage 122 of the host machine 201 on which the user VM 105 that is expected to access the files is located. A user VM 105 may be expected to access particular storage items if, for example, the storage items are associated with the user VM 105, such as by configuration information. For example, the virtual disk image 206 a may be associated with the user VM 105 a by configuration information of the user VM 105 a. Storage items may also be associated with a user VM 105 via the identity of a user of the user VM 105. For example, files and folders owned by the same user ID as the user who is logged into the user VM 105 a may be associated with the user VM 105 a. If the storage items expected to be accessed by a user VM 105 a are not stored on the same host machine 201 a as the user VM 105 a, e.g., because of insufficient available storage capacity in local storage 122 a of the host machine 201 a, or because the storage items are expected to be accessed to a greater degree (e.g., more frequently or by more users) by a user VM 105 b on a different host machine 201 b, then the user VM 105 a may still communicate with a local CVM 110 a to access the storage items located on the remote host machine 201 b, and the local CVM 110 a may communicate with local storage 122 b on the remote host machine 201 b to access the storage items located on the remote host machine 201 b. If the user VM 105 a on a host machine 201 a does not or cannot use a local CVM 110 a to access the storage items located on the remote host machine 201 b, e.g., because the local CVM 110 a has crashed or the user VM 105 a has been configured to use a remote CVM 110 b, then communication between the user VM 105 a and local storage 122 b on which the storage items are stored may be via a remote CVM 110 b using the network 140, and the remote CVM 110 b may access local storage 122 b using local communication on host machine 201 b. As another example, a user VM 105 a on a host machine 201 a may access storage items located on a disk 204 c of local storage 122 c on another host machine 201c via a CVM 110 b on an intermediary host machine 201 b using network communication between the host machines 201 a and 201 b and between the host machines 201 b and 201 c.

A metro availability solution provides a high availability approach that creates a global file system namespace across two clusters located at separate sites. An example approach that can be taken to implement synchronous replication across two virtual file servers is disclosed in U.S. Pat. No. 11,770,447, which is hereby incorporated by reference in its entirety.

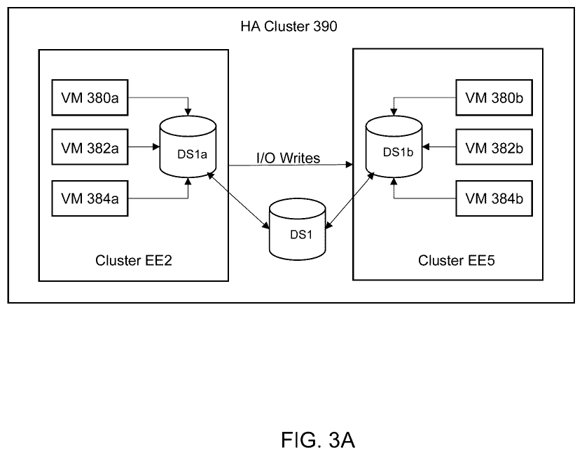

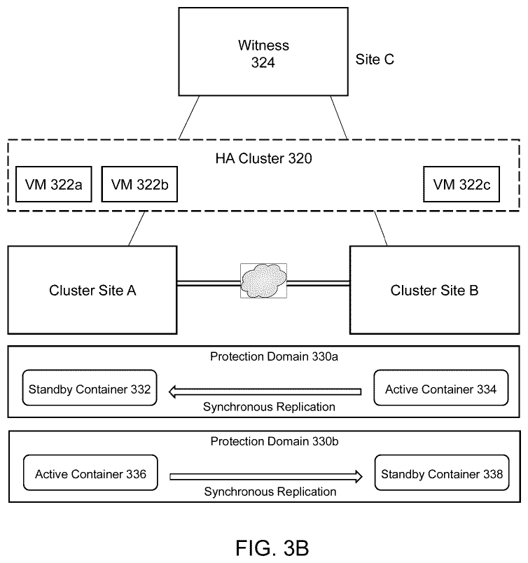

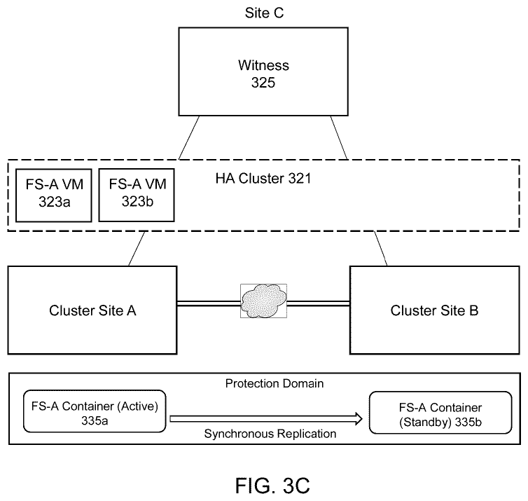

FIG. 3A show a virtualization system HA (high availability) cluster 390 for datastore “DS1”. The HA cluster 390 may be implemented as a metro availability system that spans across physically separate locations, such as different data centers within a metropolitan area, to provide continuous availability for applications and data. These “stretched” clusters (also referred to as a “stretch cluster”) achieve high availability by synchronously mirroring data between sites and leveraging host clustering technologies to automatically failover applications and restart virtual machines on the surviving site in case of a disaster. The stretch cluster shown in this figure includes a first cluster EE2 at a first site and a second cluster EE5 at a second site. The first cluster EE2 includes virtual machines 380a, 382a, and 384a that all operate against datastore DS1a. The second cluster EE2 includes VMs 380b, 382b, and 384b that all operate against datastore DS1b. It is noted that I/O operations are synchronously replicated between these two sites during normal operations.

In some embodiments, the HA cluster may be embodied using technology from a first technology vendor while the underlying virtualization/storage infrastructure may be provided by a second technology vendor. For example, a metro availability solution may be implemented where the HA cluster is implemented using technology from a first vendor such as VMWare (VMware HA cluster) while the underlying virtualization/storage infrastructure is provided by Nutanix Corporation.

As shown in FIG. 3B, the datastore “DS1” may be implemented where containers are created on both clusters, and the HA cluster sees this as a single datastore entity. Here, the HA cluster 320 may comprise a number of executing VMs, such as VM 322a, 322b, and 322c. The HA cluster 320 may be implemented as a stretch cluster across cluster site A and cluster site B.

Protection domains may be established, where content within a container on one cluster site is replicated synchronously to a container on the other site. For protection domain 330a, the active container 334 is operating at cluster site B and synchronous replication occurs to transfer contents from active container 334 to the standby container 332 on cluster site A. For protection domain 330b that operates in the other direction, the active container 336 is operating at cluster site A and synchronous replication occurs to transfer contents from active container 336 to the standby container 338 on cluster site B.

A witness 324 may be used in this type of stretch cluster to serve as a third voting member to prevent a split-brain scenario. The witness does not necessarily need to store working data, but is important for maintaining cluster quorum and ensuring high availability. A split-brain scenario occurs when a two-node cluster's communication link fails. Without a witness, both nodes would believe the other is offline. This could cause both nodes to attempt to take control of shared resources, leading to data corruption. In a two-site stretch cluster, the witness resides at a third, separate location separate from the other two cluster sites. The witness can communicate with both cluster nodes/sites and can break a tie in case of a communication failure. For example, if the communication link between the two data centers fails, at least one of the surviving data centers can usually still communicate with the witness node to win the quorum vote and remain active. The other data center will go offline, preventing a split-brain situation.

The active and standby containers mount to their respective hypervisor hosts using the same datastore name, which effectively spans the datastore across both clusters and sites. With a datastore stretched across both clusters, one can create a single virtualization system cluster and use common clustering features, such as virtual machine migration and virtualization High Availability, to manage the environment. Hosts presenting standby containers can run VMs targeted for the standby container; however, standby containers are not normally available for direct VM traffic. The system forwards all I/O targeted for a standby container to the active site.

With some embodiments, the virtual file system (Files) exists in a single storage container, so a Metro Availability solution can be leveraged to support synchronously replicated Files across clusters. This feature would need to address the gap to support failing over Files volume groups and let the solution handle failing over the file server VMs.

FIG. 3C shows an alternate embodiment where the HA cluster 321 comprises a number of executing VMs for a given fileserver (FS-A). In particular, cluster site A includes FS-A VMs 323a, 323b, etc. Even though the HA cluster 321 is implemented as a stretch cluster across cluster site A and cluster site B, in this embodiment the file server does not yet have running VMs for that file server at site B. Instead, this embodiment will have the secondary site B instantiate VMs for the file server FS-A only after a failure at site A is confirmed (e.g., based upon a quorum established using witness 325 at site C). At that point, the necessary VMs for the file server FS-A will be instantiated at site B, using the contents of the FS-A container 335b that is located at site B. This FS-A container 335b at site B has been kept up-to-date due to synchronous replication that was constantly previously performed from the FS-A container 335a at site A within the protection domain.

This approach is in contrast to the approach shown in FIG. 3B, where one or more running VMs for the file sever may be maintained at site B even though site A has not yet experienced a failure. The advantage of the FIG. 3B approach is that this can speed up HA recovery after a failure, with the downside of higher resource consumption on an ongoing basis. The advantage of the FIG. 3C approach is that this can reduce resource consumption (e.g., memory, CPU) on an ongoing basis, with the trade-off being possibly slower HA recovery after a failure.

One other point that should be mentioned is that the container can be configured to include content from any number of file servers. Therefore, as shown in FIG. 3C, the container includes files for file server FS-A. However, the invention can be implemented such that the container includes files for multiple file servers.

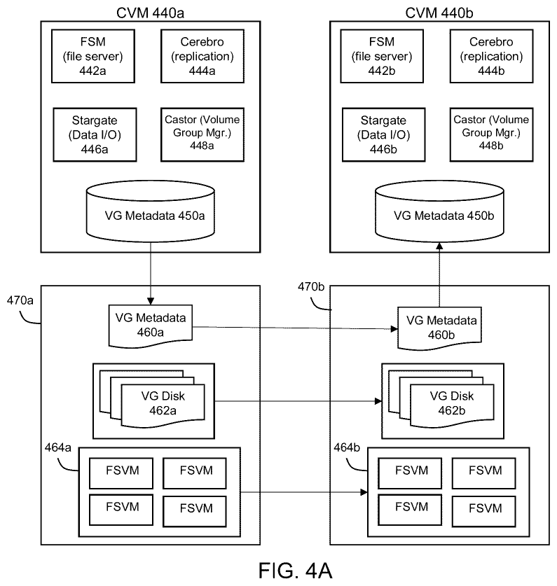

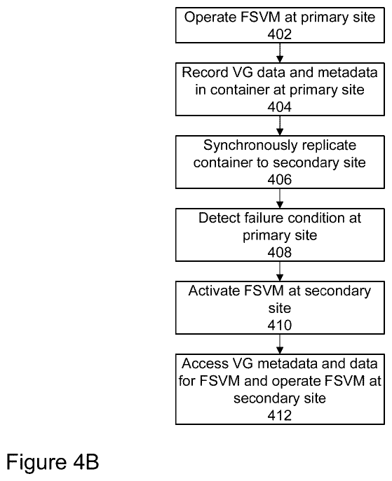

FIG. 4A shows an approach to implement some embodiments of the invention. This figure shows an illustrative cluster implementation in which a CVM (controller virtual machine) is implemented as a specialized virtual machine that runs a node in a cluster, which functions as a core component to provide platform services for the node in the cluster, essentially acting as a “brain” of the node to operate within the cluster. The CVM is often used within a hyperconverged infrastructure (HCI) to facilitate the convergence of compute and storage, in order to run a distributed operating system (such as the Acropolis Operating System (AOS)) and to handle data-related operations, including: (a) Storage I/O, where the CVM intercepts and processes all read and write requests from guest VMs running on the host, as well as managing the local storage devices (SSDs and HDDs) attached to the host; (b) Data Services, by providing data management features like deduplication, compression, erasure coding, and tiering, optimizing storage usage and performance; (c) Distributed Storage Fabric, where all CVMs in a cluster communicate with each other to form a distributed storage pool; (d) Cluster Management, where the CVMs collectively manage the cluster, handling tasks like upgrades, replication, and disaster recovery.

This figure shows a first CVM 440a at a first cluster site. The CVM 440a includes various components, including for example, a Data I/O component 446a (also referred to herein as “Stargate”), which is responsible for all data management and I/O operations and is the main interface from the hypervisor (via NFS, iSCSI, or SMB). This service runs on every node in the cluster in order to serve localized I/O. A replication/data manager component 444a (also referred to herein as “Cerebro”) is also provided, which is responsible for the replication and DR capabilities of the distributed storage fabric. This includes the scheduling of snapshots, the replication to remote sites, and the site migration/failover. Cerebro runs on every node in the cluster and all nodes participate in replication to remote clusters/sites. A volume group manager component 448a (also referred to herein as “Castor”) is provided, which is responsible for the management of volume group data and metadata. The CVM 440b at a second cluster site also includes these components, including 442b, 444b, 446b, and 448b.

While not shown in the figure, it is noted that the CVM may include other components as well, such as (a) a distributed metadata store (“Cassandra”) that stores and manages the cluster metadata in a distributed structure; (b) a cluster configuration manager (“Zookeeper”) that stores the cluster configuration information including data about hosts, IPs, state, etc.; (c) A cluster management and cleanup component (“Curator”) that is responsible for managing and distributing tasks throughout the cluster, including disk balancing, garbage collection, and proactive scrubbing; (d) a cluster management component (“Prism”), which acts as a management gateway to configure and monitor the cluster.

The first cluster site may also include a FSM 442a (File Server Module), that provide a control component for implementing virtual file servers. This component manages the file server VMs (FSVMs) that make up a Files cluster. The FSM module works with the cluster's core operating system (e.g., AOS or Acropolis Operating System), and with a cluster control component (e.g., Prism) to manage file services, e.g., to deploy a new file server instance or to manage the lifecycle of the file server. The second cluster site may also include a similar FSM 442b.

In order to ensure the proper functioning of file server volume groups within a HA cluster protection domain, it is important to maintain the volume group (VG) metadata 450a and 450b for the FSVMs. All file system operations that involve creating, modifying, or deleting a volume group should also include an update to the volume group metadata. This is to ensure consistency at all times.

This volume group metadata will be saved in a file 460a within a container. The files data for the volume groups are also stored within files 462a within the container. In addition, the data/state for the FSVMs are stored within 464a within the container 470a. The VG metadata and data stored within the container 470a can be used to recreate the volume groups on the standby site during failover processing.

In some embodiments, the synchronous storage replication supports a stretched container, allowing VMs and files stored in the container to be replicated in real-time between the two clusters. On a container basis, the contents of container 470a on a first cluster cite will be synchronously replicated to container 470b on a second cluster site. This means that the VG metadata 460a and VG disk data 462a are synchronously replicated to VG metadata 460b and VG disk data 462b, respectively. The data for the FSVMs 464a at the first cluster site are also replicated to the FSVM data 464b at the second cluster site.

FIG. 4B shows a flowchart according to some embodiments of the invention. At 402, the FSVM is operated at the primary site. The FSVM at the primary site operates as an active, key component of the scale-out file storage system. Its primary role is to serve client requests for file data, but it also works in tandem with the other FSVMs in the cluster to ensure high availability and data integrity. The FSVM at the primary site receives client connections via the client network and provides access to file shares using protocols like SMB and NFS. The FSVM is configured with a client IP address that is advertised through DNS. When a client connects, the FSVM either serves the data itself or, if the data is on a different FSVM, redirects the client to the correct one using Distributed File System (DFS) referrals.

There may be any number of FSVMs that are operating at the primary site. A Files cluster can be implemented as a single namespace made up of multiple FSVMs. The primary FSVM doesn't necessarily handle all file requests, but instead the workload is distributed across the FSVMs in the cluster.

At 404, the VG data and metadata for the FSVMs are recorded within a container at the primary site. In a stretch cluster, the volume group data and metadata for the File Server Virtual Machines (FSVMs) may not be stored as “files” within a container in the traditional sense. Instead, a highly distributed, object-based storage architecture may be employed where the container corresponds to a logical construct that holds the volume groups (VGs), which in turn contain the vDisks (virtual disks) that store the actual file data and metadata.

In some embodiments, each FSVM may be a stateless virtual machine that uses persistent storage for the file data and its own state. This persistent storage is provided by Volume Groups (VGs). Each FSVM is attached to one or more VGs via the iSCSI protocol. A Volume Group is a logical collection of vDisks, which are the actual storage devices (LUNs) seen by the FSVM. These vDisks are distributed across the nodes of the cluster. The FSVM uses these vDisks to store the file data and its internal metadata, such as file system structure, permissions, and directory information.

The role of the storage container is to act as the logical representation of a storage pool within a cluster. This is where the volume groups and their vDisks reside. When the system creates a Files instance, the system automatically creates a dedicated storage container for that instance. This container is the logical boundary for all the storage resources used by the FSVMs in that file cluster. The container may inherit properties from the underlying storage pool, such as replication factor (RF), compression, and erasure coding. This ensures that the data written to the FSVMs is automatically protected and optimized according to the policies set on the container.

File data is written to the vDisks within the volume group. The data is then broken down into “extents” (e.g., 4 KB extents) and distributed across the CVMs in the cluster. The VG Metadata, which includes the file system's “map” of where the data lives, is also stored on a dedicated set of vDisks within the volume group. This metadata is highly replicated across the cluster to ensure that the file system can be rebuilt quickly in case of a node failure.

In summary, the FSVM's volume group data and metadata are objects stored and managed by the underlying Distributed Storage Fabric (DSF). The storage container is a logical construct that contains these volume groups, ensuring that all data for a specific file server instance is managed under a single, unified policy.

At 406, the VG data and metadata are synchronously replicated from the primary site to a secondary site. In the stretch cluster, achieving synchronous replication of Volume Group (VG) data and metadata for Nutanix Files can be implemented as an automated process managed at the storage container level. For example, the “Metro Availability” feature may be used to implement the replication at the container level. This approach can be used to ensure a zero Recovery Point Objective (RPO) and high availability across the two sites.

This process can be driven by a synchronous replication policy configured from a control module (e.g., Prism Central), which pairs an active container at the primary site with a standby container at the secondary site. As client data is written to a File Server Virtual Machine (FSVM) at the primary site, the underlying Controller Virtual Machine (CVM) simultaneously writes the data to its local storage and forwards the write to a CVM at the secondary site. Acknowledgment of the write is not sent back to the FSVM until it has been confirmed at both locations, guaranteeing that the file data and its corresponding metadata are always identical across both sites.

At 408, a failure condition may be identified in the system. A witness component may be used as part of the processing, where the witness serves as an independent tiebreaker to prevent a split-brain scenario and to orchestrate an automatic failover in the event of a primary site failure. An example of a type of failure that may be identified is the failure of a communications link at or with the primary site. When the communication link between the two cluster sites fails, both sites lose visibility to each other. In this moment, the witness acts as an arbitrator, granting a leadership lock to the site that can successfully communicate with it. The primary site is then identified as down by the system when it can no longer communicate with either the secondary site or the witness. The secondary site, having secured the witness's vote, achieves quorum and automatically assumes the role of the new primary, promoting its standby storage container and activating its virtual machines to ensure business continuity with zero data loss.

Therefore in some embodiments, in the event of a primary site failure, a witness located at a third site orchestrates an automatic failover, promoting the standby container to an active state and enabling the passive FSVMs at the secondary site to begin serving client requests with immediate access to the replicated data (410), thus ensuring business continuity without any data loss.

This approach provides an advantage over approaches that may require a manual approach to implement failover. Automatic failover is superior to manual failover because it is faster, more reliable, and eliminates the risk of human error, ensuring seamless business continuity. Manual failover, in contrast, introduces significant downtime, potential data loss, and requires the constant availability of skilled IT personnel to execute the process.

At 412, the VG metadata and data for the FSVMs are accessed at the secondary site, and the restored FSVMs then proceed to handle files workloads. After a failover in a stretch cluster, the process to restore the Volume Group (VG) data and metadata at the secondary site is an automatic operation because the data has been synchronously replicated in real-time. Since the secondary site's storage container is an up-to-date, active-standby replica of the primary site's container, there is no restoration process in the traditional sense of restoring from a backup.

The core of the operation is the activation of the secondary site's resources, which already hold all the data. The storage container at the secondary site, which was in a read-only, standby state, is automatically promoted to an active, read/write state. This means that the site that was previously considered to be a “secondary” site is now the new “primary” site. This change in status gives the secondary site's CVMs full control over the data and metadata stored within the container. Since the data has been synchronously replicated, it is already completely consistent and up-to-date. The File Server Virtual Machines (FSVMs) at the secondary site, which were previously passive, are automatically powered on and activated. They gain access to the now-active storage container and its VGs. This allows them to begin serving client requests using the fully synchronized data. Clients that were connected to the primary site's FSVMs are automatically redirected to the FSVMs at the new primary site, typically through DNS updates or other network-level configurations. Because the file system namespace and all data are identical, the client experience is transparent, and service resumes with a zero RPO (Recovery Point Objective), meaning there is no data loss.

In essence, the “restoration” of the FSVMs at the secondary site is not a process of copying data back but rather a state change: the secondary site transitions from a standby, passive state to an active, primary state, instantly taking over all services with its already replicated and consistent data. This is the fundamental benefit of synchronous replication in a stretch cluster.

The current approach using metro availability may relate to certain states that may or may not correspond to a given asynchronous DR solution. Reference will be made to the various flows in the flowcharts for active protection domains and standby protection domains.

From a role perspective, the possible roles are: (a) “Active”, which is the protection domain which is sending the data; and (b) “Standby”, which is the protection domain which is receiving the data.

With regards to status states, the following states that may be used are: (a) “Enabled (In sync)”, which is where the active protection domain is replicating to the standby protection domain—this is the normal status, and every I/O must sync before it is considered a success and a commit can occur at the primary site; (b) “Synchronizing”, where the active protection domain has been enabled and it is going through the initial replication phase; (c) “Pending”, which is where a status change is in progress; (d) “Disabled”, which is when no replication is happening between the Active and Standby; (e) “Decoupled”, which is when the underlying datastore is in read-only mode, and the VMs become stunned (this is to prevent split brain scenarios); (f) “Remote unreachable”, which is when the VG manager (e.g., Cerebro) is not reachable on the remote cluster; (g) “Sync Incomplete”, which is when the initial replication from the active protection domain to the Standby has failed.

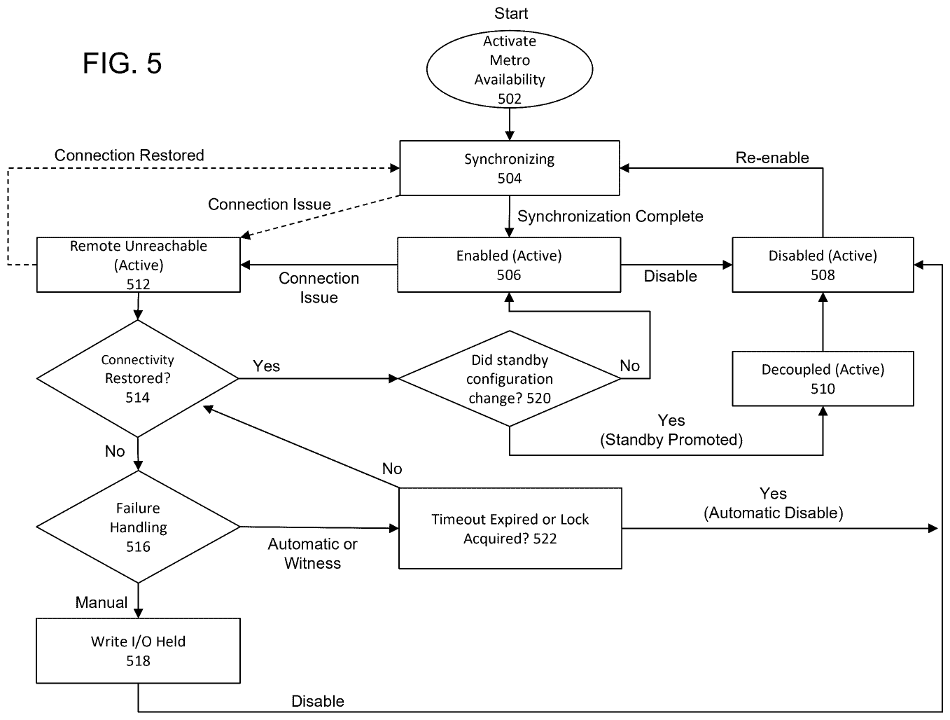

FIG. 5 shows an active protection domain flowchart for the primary site. At 502, metro availability is activated. Before this stage, nothing has been protected yet. Therefore, this action is what started the protection process.

At 504, synchronization is performed between the primary and the standby. When this is complete, the primary node goes to an active state at 506. However, if there is an issue, then the process proceeds to 512, which will continue to retry the synchronization. When disconnected, a determination can be made at 514 if connectivity is restored. If so, then the processing goes to 520. If not, then failure handling occurs at 516. At 518, manual processing may occur to write held I/O and disable and go to 508. At 522, the witness may be used to implement automated failover processing. If a timeout has expired or a lock at the witness acquired by the other node, then automatic disabling occurs and the process goes to 508.

If the node was enabled at 506, then the system is in a steady state. However, if a failure occurs (e.g., as identified above), then a different state exists, where the process proceeds to 508 (disabled active).

Next, consider when the primary site now comes back and the process proceeds to 510, where the primary is in standby and promoted state. This means that the node is in a decoupled but active state. The VMs are working and active, but decoupled so that they are not activated yet for processing work (to avoid a split brain scenario). This will become the new standby site, as shown in 508 where it is now in a disabled by active state.

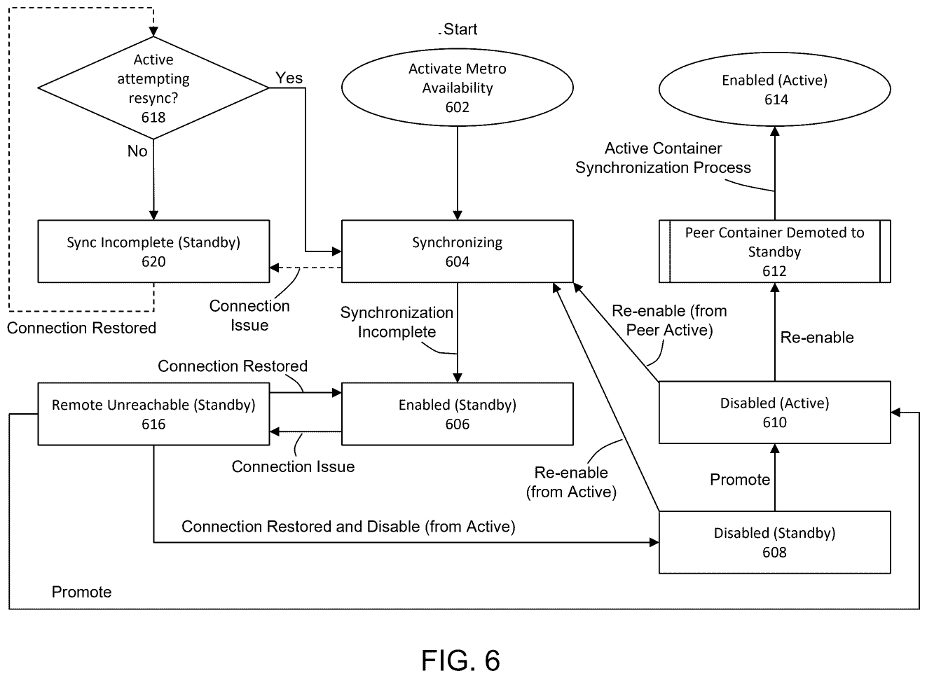

FIG. 6 shows a standby flowchart. At 602, the metro availability was previously activated at the standby. At 604, synchronization was being performed. At 606, the state at the standby (prior to a failure at the primary) was enabled standby. However, after a failure occurs at the primary, then the process proceeds to 608 where the state is disabled standby. Next, at 610, the state becomes disabled active. This “active” status means that the file server is now active at this secondary site. At 612, the peer contained is demoted to standby. At 614, a state of enabled and active is established.

If there was a connection issue, then the process goes to 620. The state here is sync incomplete. If connection is restored, then the process proceeds to 618, where a determination is made whether the active is attempting a resync. If not, then processing goes back to 620. If so, then the processing goes back to 604 for synchronization.

From 606, if a connection issue arises, then the processing goes to 616, which is a remote unreachable state. If connection is restored, then processing returns back to 606. From 616, if connection restored and disabled from active, then the process proceeds to 608 for a disabled and standby state.

It should be noted that any suitable entity can be used to implement the DR orchestrator. For example, in some embodiments, the Files Server Module (FSM) can be implemented as the DR orchestrator on the CVM.

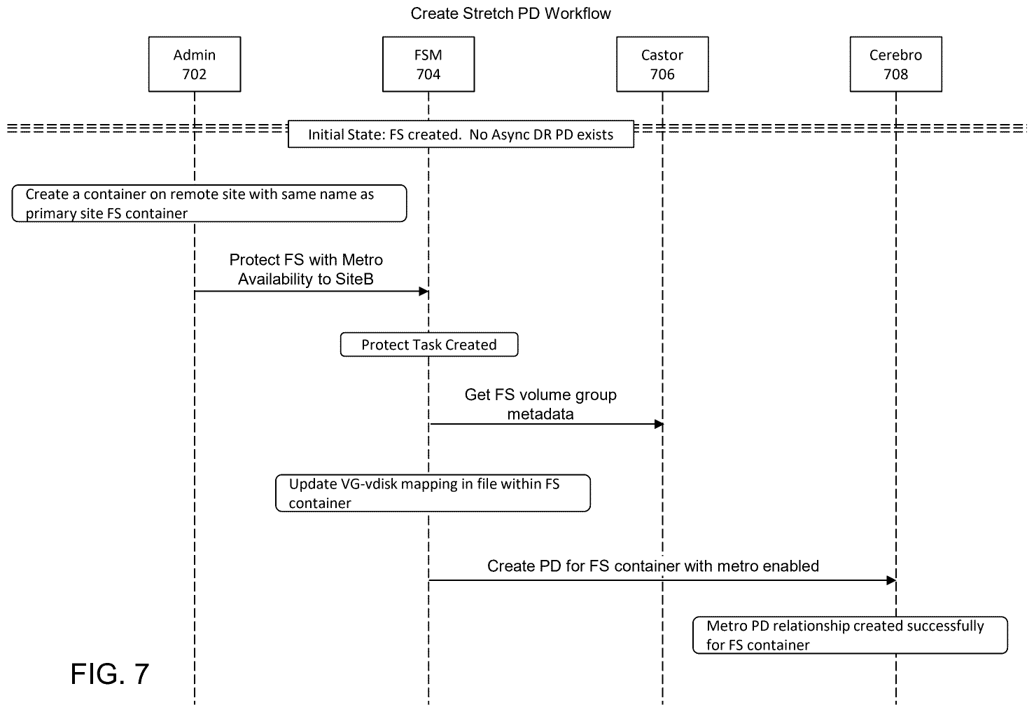

FIG. 7 shows how to create a stretch protection domain workflow. For an initial state, a HA cluster (e.g., a Vsphere cluster) is configured for AOS metro availability. A file server is also created. The admin 702 will create a container on the remote site with the same name as the file server container on the primary site. The admin 702 will protect the FSM 704 to trigger the protect task. The FS volume group metadata is obtained from Castor 706. The FSM 704 will update the VG vdisk mapping in a file within a FS container. Through Cerebro 708, a protection domain (PD) is created with metro enabled. The metro PD is created for the FS container. At this point, the FS protection state should show as being protected in the FS page on both sites. It is noted that on the recovery site, the state should be “[Not Active]”.

When implementing a process to disable/enable metro availability, similar to asynchronous PD workflows, the metro availability protection domain can be disabled and re-enabled to prevent inconsistency. These operations include actions to upgrade the FS, add a node, and remove a node. In some embodiments, the processing flow includes (1) FS task triggered; (2) Disable metro availability; (3) Continue with existing task stages; (4) Update VG metadata in container; (5) Re-enable Metro Availability; (6) Complete task.

In some embodiments, other operations should not disrupt the metro availability relationship. To support this feature, the add/delete share workflows should be able to handle site failures in the middle of the tasks while metro availability is enabled and in-sync. If a site failure occurs in the middle of share add, the system should be able to roll back to a state where VGs and share-related entities in IDF are deleted. If a site failure occurs in the middle of share delete, share-related IDF entities should be cleaned up.

With regards to failure handling and stretch parameters, in some embodiments stretch parameters are implemented as a set of parameters that both sites in a stretched cluster agree on. Containers have two primary roles while enabled for metro availability: active (primary) and standby (secondary). In the enabled case, when the containers are stretched the active site is always replicating on the standby site. When a metro availability is disabled by the user or automatically (e.g., when the remote is unreachable for more than a timeout threshold), the stretch relationship is broken. The active site is not replicating in the break condition. All the I/Os are only written on the primary site in this case. So there are 3 main categories for stretch parameters: (1) “is_stretched_primary”; (2) “is_stretched_secondary”; (3) “is_break”. These stretch params are updated every time there is a change in metro relationship. For files metro solution these stretch params state change callbacks are used for automatic promote and demote triggers.

Consider a first scenario, where there is a Site A active(primary) and Site B standby(secondary), and Site B goes down. After the break timeout the Site A protection domain changes to active—disabled, i.e. the stretch params are in break condition as there is no replication to standby site. The action to promote file server or demote file server will not be triggered in this case. To restart sync, the process is to re-enable from Site A.

Consider a second scenario, where there is a Site A active(primary) and Site B standby(secondary), and Site A goes down. After the break timeout the Site B protection domain changes to standby—remote unreachable. In some embodiments without using a witness, the user will manually promote Site B at this stage. With witness-based failure handling, Site B is automatically promoted.

When a protection domain is promoted on Site B, the current site changes to active—disabled from standby. Stretch params are in break condition from stretched secondary and the file server entity is not present. This is the trigger for promote file server.

After failure recovery, Site A enters Active—decoupled state. In this stage the container is read only. Stretch params are in stretch primary condition with “decoupled:true” and the file server entity is present. This is the trigger for demote file server. There are multiple triggers for demote.

In some embodiments a site failure workflow is processed with the following: (1) In an initial state, the metro PD created, and in-sync is enabled; (2) An event is detected, which is an outage on Site A; (3) Failure handling is performed which promotes the metro PD; (4) At Site B, Cerebro marks metro PD enabled; (5) At Site B, the stretch params are updated; (6) At Site B, the FSM watch on stretch_params is triggered; (7) at Site B, the FSM starts FS promote.

In some embodiments, active site recovery (with site B Active) is processed with the following: (1) In an initial state, Site A is down and Site B PD has been promoted, as well as the file server; (2) Site A recovers and is now available; (3) Cerebro on Site A marks PD metro status as decoupled; (4) FSM will detect this state and demote the FS; (5) the metro PD is disabled on site A; (6) At Site B, metro PD is reenabled on site B; (7) Once the metro PD is enabled and in-sync, the system brings the FS back to the original primary site (Site A).

This next portion of the disclosure will now describe an alternate approach to implement some embodiments of the invention, where entity-based replication is performed instead of the container-based replication that was described above. As previously noted, the system comprises a set of highly available File Server virtual machines (FSVMs) that get deployed on the platform. These FSVMs are backed by virtual entities, such as for example, virtual disks (vdisks) and Volume Groups or VGs (a grouping of vdisks). These entities are then mounted to the FSVMs. The FSVMs are then aggregated together to form a single namespace that becomes the file server name that the end users will access (e.g.,: \\files.hq.com). As users mount exports or map drives to the shares, the data written to the file server is stored within these entities.

When focusing on disaster recovery and data availability with synchronous replication, the need to protect these entities that make up the file server is where a metro cluster configuration comes into play. It is accomplished through creating a synchronous replication relationship using metro availability for VMs and VGs. Internally, this translates to using an entity centric disaster recovery capability leveraging protection policies with RPO 0 and recovery plans for orchestrating the protection and recovery at entity level granularity.

Therefore, the approach of the current embodiments of the invention is where a storage-based paradigm is employed to synchronously replicate the information from a primary site to a secondary site, and it is noted that there are alternative ways to do this replication. As described in detail above, one possible approach is to use container-based replication, where the file server data/metadata are held as files in a container and then replicated between the sites. This portion of the disclosure describes an alternate approach where entity-based replication is used.

When metro availability is configured, whether for Files or user application VMs, the system is synchronously replicating the entities themselves. With the assistance of a witness service and Prism Central (PC), when a failure is detected that results in the primary cluster becoming unavailable, all file server entities will be brought up on the cluster configured as the secondary site.

With that understanding, what follows is an explanation into more technical details. This description will cover what happens when failure or service impacting events arise. These events can range from one side of the relationship going offline, whether planned or unplanned, to the link between primary and secondary going down/offline or the management layer, Prism Central, not being available.

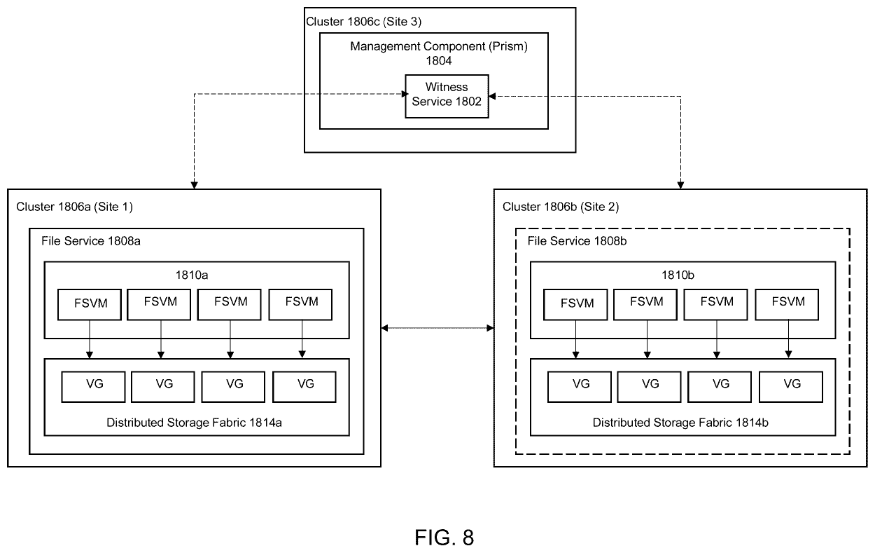

To fully explain how the solution works end to end, consider some common failure scenarios and see how the system maintains high availability. Consider a deployment scenario as shown in FIG. 8.

Here, cluster 1806a on Site 1 hosts the active Files instance 1808a which consists of Files Server VMs (FSVMs) 1810a deployed across different nodes of the cluster consuming Volume Groups (VGs) backed by a distributed storage fabric 1814a. Cluster 1806b on cluster site 2 hosts replicas of the FSVMs (1810b), VGs on storage fabric 1814b and required data and metadata for consumption in the case of disasters. These resources are offline and will be promoted (started) when a service impacting event (planned or unplanned) on Site 1 impacts the active file server availability. The standby Files instance 1808b is shown in dashed lines to indicate that this instance is in a standby mode and thus is not yet active.

Cluster 1806c on Site 3 hosts a witness service, which is a component that provides tie-breaker functionality in the case of network partitions to ensure that only one instance of the file servers is active at a time. As a part of this deployment in some embodiments, the witness service is hosted inside a Prism Central. “Prism Central” can be embodied as a management plane responsible for overseeing managed components across sites, and can be implemented as a centralized management service that provides visibility, configuration and monitoring capabilities.

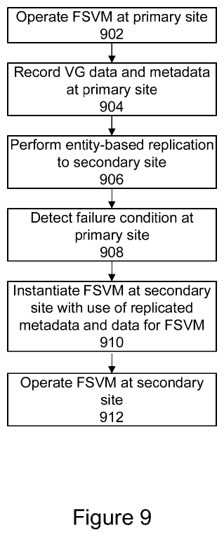

FIG. 9 shows a flowchart according to some embodiments of the invention for performing entity-based replication. At 902, the FSVM is operated at a primary site in a stretch cluster. At 904, VG data and metadata are recorded at the primary site. Within the cluster, the concept of a Volume Group (VG) is itself an entity. The system records VG data and metadata by treating the VG as a first-class object, distinct from a storage container, and managing it at a granular level. This is the foundation of entity-based replication, as opposed to the container-based approach. Therefore, a logical entity can be a VG, which is a logical collection of virtual disks (vDisks) that can be attached to one or more VMs or physical hosts. Each VG is an independent entity, and its configuration and state are recorded within the Distributed Storage Fabric (DSF). The metadata for a VG, which includes information on its vDisks, their locations, and a map of where all the data is stored, is not kept in a single file. Instead, it's an object that is distributed and replicated across all the CVMs in the cluster using an internal, distributed database (e.g., using Cassandra). This distributed approach ensures that the metadata is highly available and resilient to node failures.

At 906, entity-based replication is performed to the secondary site for both the VG data and metadata. The “entity-based” approach extends to data protection, and as such, rather than applying a replication policy to a container, which would affect all VGs within it, the policy is applied directly to the VG entity itself. This allows for fine-grained control, where one can set different replication schedules and RPOs (Recovery Pointives) for each individual VG based on the criticality of the application it supports.

With regards to their relationship to VMs, the VGs are also related to other entities, such as VMs, which can be tagged with categories. Protection policies linked to those categories can automatically include VGs attached to those VMs. This creates a powerful, policy-driven automation system where a new application can be protected simply by tagging its VMs with a predefined category.

While a Files instance is fundamentally a collection of FSVMs, its data protection using entity-based replication operates at a finer, more intelligent level than just replicating the FSVMs. The key is that the File Server itself can also be treated as a logical entity, and its protection is managed in a holistic, orchestrated way.

With regards to entity-based replication to protects File Server VMs, a Files instance can be considered a single, protected entity. When setting up disaster recovery for Files, one can therefore not individually select the FSVMs and their VGs. Instead, in some embodiments, selection can be made of a File Server instance. When setting up a replication/protection policy, the policy is aware of the components that make up the file server, including the FSVMs, the volume groups they use, and all the shares and exports they provide.

It is noted that the concept of “entity” may be applied at any level of granularity in embodiments of the invention. As previously noted, the invention can be implemented such that a Files instance can be considered a single, protected entity. However, the concept of entity can also be applied at the FSVM level, the VG, level, or even with multiple grouped file servers. For example, a “category” can be established that group similar, related, co-dependent, or environmentally-related entities together into a group of entities that are managed together. For instance, all file server entities that perform a similar function may be grouped together into an appropriate category. As another example, a file server entity may be grouped with a network-related entity (e.g., a networking VM), since they both relate to the common environment which the FS operates, and this forms a nested top level entity that include both the FS entity and the networking entity.

For holistic replication purposes, when performing replication jobs, the system can make sure that the related entities are replicated together as a consistency group, to ensure data integrity. If only the VGs were replicated without the FSVMs, the system would have the data but no “brain” to serve it. The replication includes not only the file data on the VGs but also the FSVMs' boot disks and internal metadata, which contain the file system state and configuration.

In the context of metro availability, this means that on an entity-basis, the system provides a zero data loss (RPO=0) solution that provides continuous availability for mission-critical applications across two separate sites. It achieves this by creating a stretched cluster and using synchronous replication to mirror entity-based data in real time between the two sites.

Metro Availability operates by treating protected VMs and their associated volume groups (VGs) as a single, consistent entity. This means that the system is not just replicating a disk in isolation, but is instead replicating the entire workload, ensuring that if one site fails, the application can continue running on the other site with zero data loss and minimal disruption. All writes to a VM or VG at the active site are synchronously replicated to the standby site before the write is acknowledged as complete. This guarantees that both copies of the data are always identical. The low latency required between the two sites is necessary to ensure this process does not cause a noticeable performance degradation for the applications. To ensure data integrity, especially for multi-VM applications like a database with a separate application server, Metro Availability places all related entities into a consistency group. This ensures that snapshots and replication are performed across all entities in the group at the exact same point in time, guaranteeing a crash-consistent state at the recovery site.

At 908, a failure condition may be identified at the primary site. A third, out-of-band site or cloud service acts as a Witness. Its role is to prevent a “split-brain” scenario in case of a network failure between the two sites. The Witness acts as a tiebreaker, allowing the site that can still communicate with it to remain active and continue processing I/O, while the isolated site goes into a read-only state. The witness can be used to confirm the failure at the primary site.

At 910, failover occurs to the secondary site, where the FSVM is activated with use of the previously replicated VG data and metadata. An entity-based failover to a secondary site is an orchestrated, using an automated process that, e.g., treats the entire file server instance as a single logical entity. This is managed by considering that all components—FSVMs, volume groups, and their metadata—are protected and recovered together to ensure a seamless and consistent state at the secondary site. The system promotes the FSVMs and their volume groups at the secondary site to a read-write state.

In some embodiments, the same IP address is used for the file server instance at the secondary site, where IP address migration occurs from the primary site. This approach allows the system to bring up the file server with the same IP address so the failover is seamless for clients. In other embodiments, the system re-registers the file server instance with the new IP addresses at the secondary site. Updates may be orchestrated to DNS and Active Directory (AD), where updates to the DNS records and the Service Principal Names (SPNs) in AD point to the FSVMs' new IP addresses at the recovery site. This ensures that clients, which are typically connected via a fully qualified domain name (FQDN), can automatically reconnect to the file shares without needing manual reconfiguration.

At 912, workloads are then performed and conducted using the FSVMs at the secondary/recovery site. After the failover is complete and DNS/AD entries are updated, clients that were connected to the primary file server will automatically re-establish their connections to the newly active file server at the secondary site. This is a key benefit of the entity-based approach, as it minimizes the disruption to end-users and applications. In some embodiments, the actions of 910 and 912 are performed in parallel, rather than sequentially.

In summary, the relationship between entity-based replication and File Server VMs is that the replication system intelligently recognizes the File Server as a cohesive entity. It simplifies a complex replication and recovery process into a single, automated, and orchestrated workflow, ensuring that the file service, and not just the raw data, is protected and can be restored quickly and reliably.

One main advantage of the entity-based approach over the container-based approach is that the container approach handles replication and recovery at the level of every file within the container. This means that the granularity that is handled with container-based replication may span multiple entities. In contrast, the entity-based approach can be focused on any number of individual entities. This therefore provides flexibility for the system so that even a subset of the files within the container can be addressed individually on an entity basis. As such, this approach allows the system to perform repairs and recovery at a much more granular level as compared to the container-based approach.

Several scenarios will now be described, where the file server will be active on Cluster 1 to begin with. Consider a scenario where there is a failure on the Production Site (Site 1). The recovery procedure in some embodiments may include: (1) Each cluster should be in active metro availability with data available on both cluster before the outage occurs; (2) Cluster 2 detects an outage on Cluster 1 due to heartbeat failures; (3) After a user-configured timeout (e.g., where default=30 secs), Cluster 2 will attempt to acquire exclusive ownership of the file server via the Witness Service and succeeds; (4) Unplanned failover is initiated on Cluster 2, where (i) this results in the file server on Cluster 2 becoming independent and no longer in synchronous replication, with all further updates persisted locally; (ii) Once all file server entities (FSVMs+VGs) have failed over, the file server is promoted (activates and starts); (iii) After the file server completes initialization, the shares and exports will be accessible to clients again; (5) When Cluster 1 recovers later, synchronous replication is automatically re-established for the file server and any delta changes are synced to get back into metro availability; (6) As a part of the above process, the now stale FSVMs and VGs on Cluster 1 are automatically cleaned up since the file server is now active on Cluster 2.

Consider a second scenario, where there is a network partition between sites but both sites can access the 3rd site. The recovery procedure in some embodiments may include: (1) Cluster 1 and Cluster 2 will consider the other as not reachable due to heartbeat failures; (2) After the user-configured timeout, both clusters will attempt to claim exclusive ownership of the file server via the Witness Service; (3) Witness Service will resolve the tie and the winner (in this case, Cluster 1) will become the exclusive owner of the file server; (4) Synchronous replication will be paused on Cluster 1, and all further updates to the file server entities (FSVMs+VGs) will be persisted locally; (5) Once the network partition is resolved, the administrator can manually resume synchronous replication on the file server to get it back into metro availability. This can be done through Files UI on PC.

Consider a third scenario, where there is a DR (disaster recovery) Site Failure. The recovery procedure in some embodiments may include: (1) Cluster 1 detects an outage on Cluster 2 due to heartbeat failures; (2) After the user-configured timeout, Cluster 1 will attempt to claim exclusive ownership of the file server via the Witness Service and succeed; (3) Synchronous replication will be paused on Cluster 1, and all further updates to the file server entities (FSVMs+VGs) will be persisted locally; (4) Once the network partition is resolved, the administrator can manually resume synchronous replication on the file server to get it back into metro availability. This can be done through Files UI on PC.

Consider a fourth scenario, where there is a production site network isolation. The recovery procedure in some embodiments may include: (1) Cluster 1 and Cluster 2 will detect heartbeat failures from their respective peers; (2) Cluster 1 and Cluster 2 will both periodically attempt to contact Witness Service on Cluster 3; (3) Cluster 1 will be unable to reach the Witness Service for a sustained period and will pre-emptively revoke storage access to the file server entities (FSVMs+VGs), and this action is taken to prevent the file server from being accessible from both clusters simultaneously along with powering off the FSVMs; (4) After the user-configured timeout, Cluster 2 will acquire exclusive ownership of the file server via the Witness Service and initiate an unplanned failover, which results in the file server on Cluster 2 becoming independent and no longer in synchronous replication, with all further updates persisted locally. Once all file server entities have failed over, the file server is promoted (activates and starts), and after the file server completes initialization, the shares and exports will be accessible to clients again; (5) If Cluster 1 recovers later, synchronous replication is automatically re-established for the file server and any delta changes are synced to get back into metro availability; (6) As a part of the above process, the now stale FSVMs and VGs on Cluster 1 are automatically cleaned up since the file server is now active on Cluster 2.

Therefore, what has been described are techniques used in systems, methods, and in computer program products for an improved approach to implement high availability for file servers in a virtualized computing environment. In particular, for a “metro availability” environment, embodiments of the invention provide a high availability solution that creates a global file system namespace across two clusters located at separate sites, where a synchronous storage replication is used to support the stretched container, allowing VMs and files stored in the container to be replicated in real-time between the two clusters.

### System Architecture Overview

### Additional System Architecture Examples

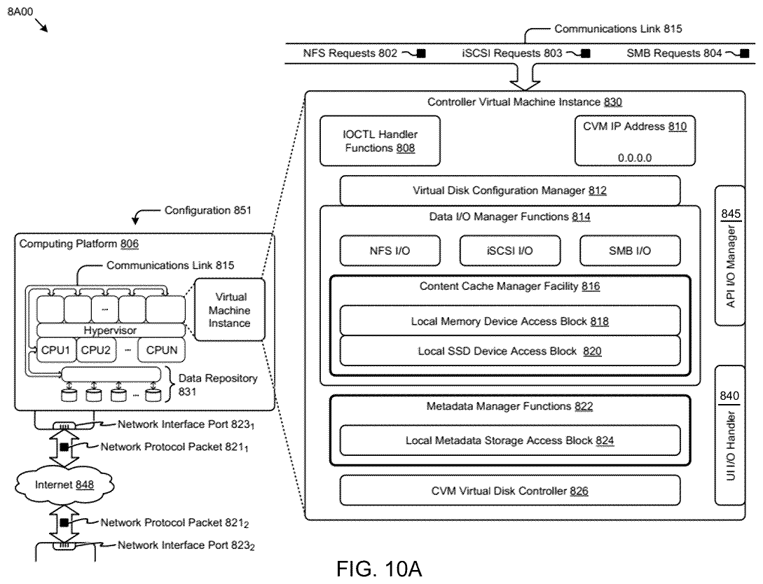

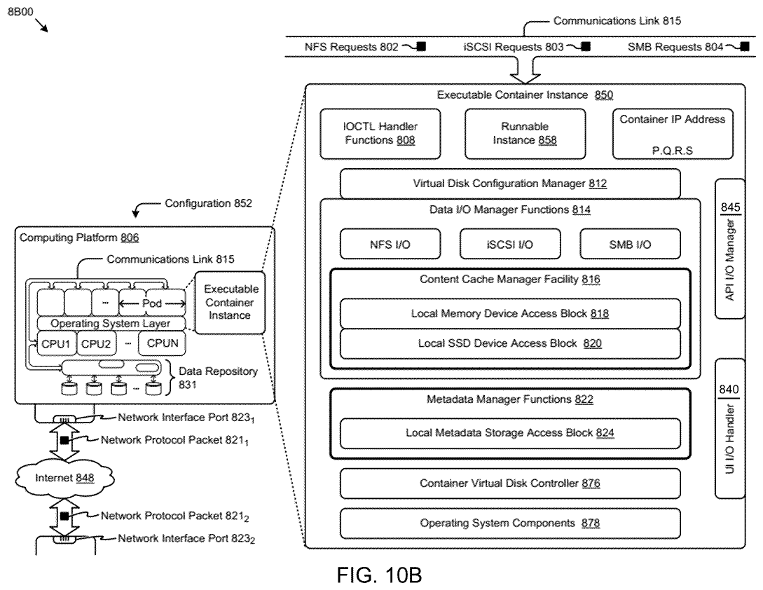

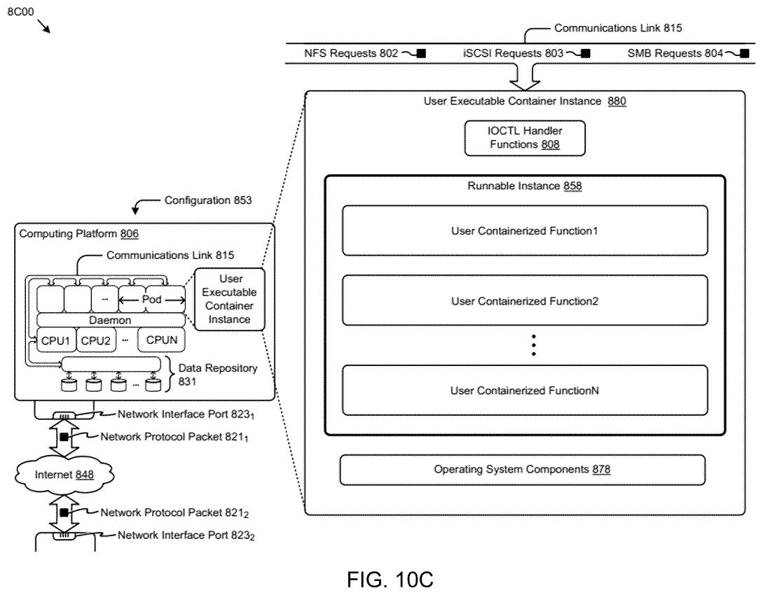

FIG. 10A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O (input/output or IO) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to fault tolerant access to file servers in multi-cluster computing environments. In some embodiments, a module may include one or more state machines and/or combinational logic used to implement or facilitate the operational and/or performance characteristics pertaining to fault tolerant access to file servers in multi-cluster computing environments.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fault tolerant access to file servers in multi-cluster computing environments). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to fault tolerant access to file servers in multi-cluster computing environments, and/or for improving the way data is manipulated when performing computerized operations pertaining to implementing a high-availability file server capability by automatically directing file I/O requests to one of two or more synchronized file servers in accordance with the then-current status (e.g., health) of the file servers.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 10B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container or as a controller executable container. Any executable container of any sort can be rooted in a directory system, and can be configured to be accessed by file system commands (e.g., “ls” or “ls-a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 10C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

The virtual machine architecture 8A00 of FIG. 10A and/or the containerized architecture 8B00 of FIG. 10B and/or the daemon-assisted containerized architecture 8C00 of FIG. 10C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A computer implemented method, comprising:
maintaining a high availability (HA) system configuration comprising a primary site and a secondary site, wherein a stretch computing cluster extends across both the primary site and a secondary site;
implementing a file server virtual machine at the primary site, the file system virtual machine corresponding to volume group metadata that maps files and directories on virtualized volume groups;
performing synchronous replication between the primary site and the secondary site across the stretch computing cluster, wherein the replication is performed to replicate the volume group metadata and the virtualized volume group disks to the secondary site;
detecting a failure condition that affects the primary site;
using a witness service to determine that failover should occur for the file server virtual machine from the primary site to the secondary site, wherein the witness makes a determination that the failure condition has caused the file server virtual machine to be in a status condition that is unavailable to process operation fileserver workloads; and
wherein the failover occurs by causing the file server virtual machine at the primary site to become inactive and causing a secondary file server virtual machine at the secondary site to become active, wherein replicated volume group metadata at the secondary site is used to activate the secondary file server virtual machine at the secondary site to manage the files and the directories from replicated virtualized volume groups.

2. The method of claim 1, wherein the synchronous replication between the primary site and the secondary site across the stretch computing cluster is performed using entity-based replication.

3. The method of claim 2, wherein the entity-based replication comprises replication of an entity at a granularity of the file server virtual machine.

4. The method of claim 2, wherein the failover corresponds to an entity-based failover at a granularity of the file server virtual machine.

5. The method of claim 1, wherein the synchronous replication between the primary site and the secondary site across the stretch computing cluster is performed using container-based replication.

6. The method of claim 5, wherein the container-based replication performs replication for files within a container.

7. The method of claim 5, wherein the container-based replication corresponds to a protection domain.

8. A system for using a microservices container registry, the system comprising:
a storage medium having stored thereon a sequence of instructions; and
a processor that executes the sequence of instructions to cause the processor to perform acts comprising: maintaining a high availability (HA) system configuration comprising a primary site and a secondary site, wherein a stretch computing cluster extends across both the primary site and a secondary site; implementing a file server virtual machine at the primary site, the file system virtual machine corresponding to volume group metadata that maps files and directories on virtualized volume groups; performing synchronous replication between the primary site and the secondary site across the stretch computing cluster, wherein the replication is performed to replicate the volume group metadata and the virtualized volume group disks to the secondary site; detecting a failure condition that affects the primary site; using a witness service to determine that failover should occur for the file server virtual machine from the primary site to the secondary site, wherein the witness makes a determination that the failure condition has caused the file server virtual machine to be in a status condition that is unavailable to process operation fileserver workloads; and wherein the failover occurs by causing the file server virtual machine at the primary site to become inactive and causing a secondary file server virtual machine at the secondary site to become active, wherein replicated volume group metadata at the secondary site is used to activate the secondary file server virtual machine at the secondary site to manage the files and the directories from replicated virtualized volume groups.

9. The system of claim 8, wherein the synchronous replication between the primary site and the secondary site across the stretch computing cluster is performed using entity-based replication.

10. The system of claim 9, wherein the entity-based replication comprises replication of an entity at a granularity of the file server virtual machine.

11. The system of claim 9, wherein the failover corresponds to an entity-based failover at a granularity of the file server virtual machine.

12. The system of claim 8, wherein the synchronous replication between the primary site and the secondary site across the stretch computing cluster is performed using container-based replication.

13. The system of claim 12, wherein the container-based replication performs replication for files within a container.

14. The system of claim 12, wherein the container-based replication corresponds to a protection domain.

15. A non-transitory computer readable medium having stored thereon a sequence of instructions which, when stored in memory and executed by a processor cause the processor to perform acts, the acts comprising:
maintaining a high availability (HA) system configuration comprising a primary site and a secondary site, wherein a stretch computing cluster extends across both the primary site and a secondary site;
implementing a file server virtual machine at the primary site, the file system virtual machine corresponding to volume group metadata that maps files and directories on virtualized volume groups;
performing synchronous replication between the primary site and the secondary site across the stretch computing cluster, wherein the replication is performed to replicate the volume group metadata and the virtualized volume group disks to the secondary site;
detecting a failure condition that affects the primary site;
using a witness service to determine that failover should occur for the file server virtual machine from the primary site to the secondary site, wherein the witness makes a determination that the failure condition has caused the file server virtual machine to be in a status condition that is unavailable to process operation fileserver workloads; and
wherein the failover occurs by causing the file server virtual machine at the primary site to become inactive and causing a secondary file server virtual machine at the secondary site to become active, wherein replicated volume group metadata at the secondary site is used to activate the secondary file server virtual machine at the secondary site to manage the files and the directories from replicated virtualized volume groups.

16. The non-transitory computer readable medium of claim 15, wherein the synchronous replication between the primary site and the secondary site across the stretch computing cluster is performed using entity-based replication.

17. The non-transitory computer readable medium of claim 16, wherein the entity-based replication comprises replication of an entity at a granularity of the file server virtual machine.

18. The non-transitory computer readable medium of claim 6, wherein the failover corresponds to an entity-based failover at a granularity of the file server virtual machine.

19. The non-transitory computer readable medium of claim 15, wherein the synchronous replication between the primary site and the secondary site across the stretch computing cluster is performed using container-based replication.

20. The non-transitory computer readable medium of claim 19, wherein the container-based replication performs replication for files within a container.

21. The non-transitory computer readable medium of claim 19, wherein the container-based replication corresponds to a protection domain.
